(19) United States
(12) Patent Application Publication
(10) Pub. No.: US 2023/0036275 A1
(43) Pub. Date: Feb. 2, 2023

(54) BUS BAR CONFIGURATIONS FOR CONNECTING BATTERY PACK COMPONENTS

(71) Applicant: FORD GLOBAL TECHNOLOGIES, LLC, Dearborn, MI (US)

(72) Inventors: Liam E. WEST, Ferndale, MI (US); Daniel Roberts, Livonia, MI (US); Francisco FERNANDEZ-GALINDO, Canton, MI (US)

(21) Appl. No.: 17/388,141

(22) Filed: Jul. 29, 2021

(51) Int. Cl. H01M 50/502; H01M 50/543; H01M 10/0525; H01M 50/209

(52) U.S. Cl. CPC H01M 50/502; H01M 10/0525; H01M 50/209; H01M 50/543; H01M 2220/20

(57) ABSTRACT

Exemplary bus bar assemblies may be used to electrically couple adjacent components of electrified vehicle traction battery packs, for example. An exemplary bus bar assembly includes a flexible braided design that may be packaged out of position and secured via a clip for shipping and handling and then folded into a position suitable for traction battery pack component assembly. Another exemplary bus bar assembly includes a semi-rigid design having tight tolerances and reliefs designed into the part to allow for fastening two adjacent traction battery pack components in a specific order to allow for component overlapping.

### TECHNICAL FIELD

This disclosure relates generally to electrified vehicle traction battery packs, and more particularly to bus bar assemblies configured for electrically coupling traction battery pack components.

### BACKGROUND

Electrified vehicles are designed to reduce or completely eliminate reliance on internal combustion engines. In general, electrified vehicles differ from conventional motor vehicles because they are selectively driven by battery powered electric machines. Conventional motor vehicles, by contrast, rely exclusively on the internal combustion engine to propel the vehicle.

A high voltage traction battery pack typically powers the electric machines and other electrical loads of the electrified vehicle. The traction battery pack includes a plurality of battery arrays that each include groupings of battery cells for powering the electric propulsion of electrified vehicles. Adjacent battery arrays must be reliably connected to one another in order to achieve the voltage and power levels necessary to propel the vehicle.

### SUMMARY

A battery pack according to an exemplary aspect of the present disclosure includes, among other things, a first electrical component, a second electrical component, and a bus bar assembly configured to electrically couple the first and second electrical components. The bus bar assembly includes a terminal section, an internal bus bar section, and a flexible braided mesh section extending between the terminal section and the internal bus bar section. The flexible braided mesh section is movable between a folded position and an unfolded position to alter a positioning of the terminal section relative to the internal bus bar section.

In a further non-limiting embodiment of the foregoing battery pack, the first electrical component is a first battery array and the second electrical component is a second battery array.

In a further non-limiting embodiment of either of the foregoing battery packs, the first electrical component is a battery array and the second electrical component is a bussed electrical center (BEC).

In a further non-limiting embodiment of any of the foregoing battery packs, the terminal section is fastened to a high voltage terminal of the second electrical component when the flexible braided mesh section is positioned in the unfolded position.

In a further non-limiting embodiment of any of the foregoing battery packs, the high voltage terminal is connected to a battery cell terminal tab.

In a further non-limiting embodiment of any of the foregoing battery packs, the terminal section is fastened to the high voltage terminal with a fastener and a fastener receiver of the second electrical component.

In a further non-limiting embodiment of any of the foregoing battery packs, the internal bus bar section is L-shaped and the terminal section is configured in the form of an eyelet.

In a further non-limiting embodiment of any of the foregoing battery packs, the internal bus bar section is connected to a battery cell terminal tab of the first electrical component.

In a further non-limiting embodiment of any of the foregoing battery packs, the terminal section at least partially overlaps the internal bus bar section in the folded position and is displaced from the internal bus bar section in the unfolded position.

In a further non-limiting embodiment of any of the foregoing battery packs, a flexible clip is adapted to engage the terminal section to hold the flexible braided mesh section in the folded position.

A battery pack according to another exemplary aspect of the present disclosure includes, among other things, a first electrical component, a second electrical component, and a bus bar assembly configured to electrically couple the first and second electrical components. The bus bar assembly includes a terminal section, an internal bus bar section, and a top hat section connecting between the terminal section and the internal bus bar section.

In a further non-limiting embodiment of the foregoing battery pack, the bus bar assembly includes a semi-rigid structure.

In a further non-limiting embodiment of either of the foregoing battery packs, the first electrical component is a first battery array and the second electrical component is a second battery array.

In a further non-limiting embodiment of any of the foregoing battery packs, the first electrical component is a battery array and the second electrical component is a bussed electrical center (BEC).

In a further non-limiting embodiment of any of the foregoing battery packs, the internal bus bar section is L-shaped and the terminal section is configured in the form of an eyelet.

In a further non-limiting embodiment of any of the foregoing battery packs, the internal bus bar section is connected to a battery cell terminal tab of the first electrical component.

In a further non-limiting embodiment of any of the foregoing battery packs, the terminal section is fastened to a high voltage terminal of the second electrical component.

In a further non-limiting embodiment of any of the foregoing battery packs, the terminal section is fastened to the high voltage terminal with a fastener and a fastener receiver of the second electrical component.

In a further non-limiting embodiment of any of the foregoing battery packs, the top hat section extends in a first horizontal plane that is vertically offset from a second horizontal plane established by the terminal section and a third horizontal plane established by the internal bus bar section.

In a further non-limiting embodiment of any of the foregoing battery packs, the second horizontal plane is vertically offset from the third horizontal plane.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a bus bar assembly for electrically coupling together adjacent traction battery pack components.

FIG. 3 illustrates an exemplary flexible bus bar assembly.

FIG. 4 illustrates a folded configuration of the bus bar assembly of FIG. 3.

FIG. 5 illustrates an unfolded configuration of the bus bar assembly of FIG. 3.

FIG. 6 illustrates another exemplary bus bar assembly.

FIG. 7 illustrates the bus bar assembly of FIG. 6 in a configuration for coupling together adjacent traction battery pack components.

### DETAILED DESCRIPTION

This disclosure details exemplary bus bar assembly designs, such as those configured for electrically coupling adjacent components of electrified vehicle traction battery packs, for example. An exemplary bus bar assembly includes a flexible braided design that may be packaged out of position and secured via a clip for shipping and handling and then folded into a position suitable for traction battery pack component assembly. Another exemplary bus bar assembly includes a semi-rigid design having tight tolerances and reliefs designed into the part to allow for fastening two adjacent traction battery pack components in a specific order to allow for component overlapping. These and other features are discussed in greater detail in the following paragraphs of this detailed description.

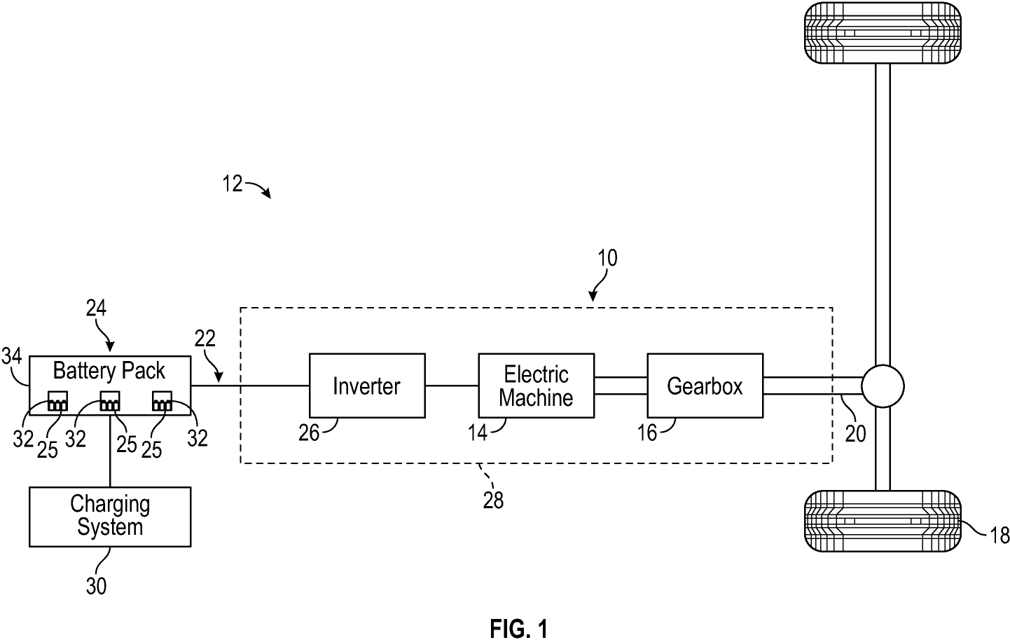

FIG. 1 schematically illustrates a powertrain 10 of an electrified vehicle 12. In an embodiment, the electrified vehicle 12 is a battery electric vehicle (BEV). However, it should be understood that the concepts described herein are not limited to BEVs and could extend to other electrified vehicles, including, but not limited to, hybrid electric vehicles (HEVs), plug-in hybrid electric vehicles (PHEVs), fuel cell vehicles, etc. Although not shown in this exemplary embodiment, the electrified vehicle 12 could be equipped with an internal combustion engine that can be employed either alone or in combination with other energy sources to propel the electrified vehicle 12.

In the illustrated embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output torque. The electric machine 14 may be connected to a gearbox 16 for adjusting the output torque and speed of the electric machine 14 by a predetermined gear ratio. The gearbox 16 is connected to a set of drive wheels 18 by an output shaft 20.

A voltage bus 22 electrically connects the electric machine 14 to a traction battery pack 24 through an inverter 26, which can also be referred to as an inverter system controller (ISC). The electric machine 14, the gearbox 16, and the inverter 26 may be collectively referred to as a transmission 28 of the electrified vehicle 12.

The traction battery pack 24 is an exemplary electrified vehicle battery. The traction battery pack 24 may be a high voltage traction battery pack that includes one or more battery arrays 25 (i.e., battery assemblies or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The one or more battery arrays 25 of the traction battery pack 24 may include a plurality of battery cells 32 that store energy for powering various electrical loads of the electrified vehicle 12. The traction battery pack 24 could employ any number of battery cells 32 within the scope of this disclosure. Accordingly, this disclosure should not be limited to the exact configuration shown in FIG. 1.

In an embodiment, the battery cells 32 are lithium-ion cells. However, other cell chemistries (nickel-metal hydride, lead-acid, etc.) could alternatively be utilized within the scope of this disclosure.

In another embodiment, the battery cells 32 are cylindrical or prismatic battery cells. However, other cell geometries could alternatively be utilized within the scope of this disclosure.

An enclosure assembly 34 may house the battery arrays 25 of the traction battery pack 24. The enclosure assembly 34 may include any size, shape, and configuration within the scope of this disclosure.

The electrified vehicle 12 may also include a charging system 30 for charging the energy storage devices (e.g., the battery cells 32) of the traction battery pack 24. The charging system 30 may include charging components that are located both onboard the electrified vehicle 12 (e.g. vehicle charge port assembly, etc.) and external to the electrified vehicle 12 (e.g., electric vehicle supply equipment (EVSE), etc.). The charging system 30 can be connected to an external power source (e.g., a grid power source) for receiving and distributing power received from the external power source throughout the electrified vehicle 12.

The powertrain 10 depicted by FIG. 1 is highly schematic and is not intended to limit this disclosure. Various additional components could alternatively or additionally be employed by the powertrain 10 within the scope of this disclosure.

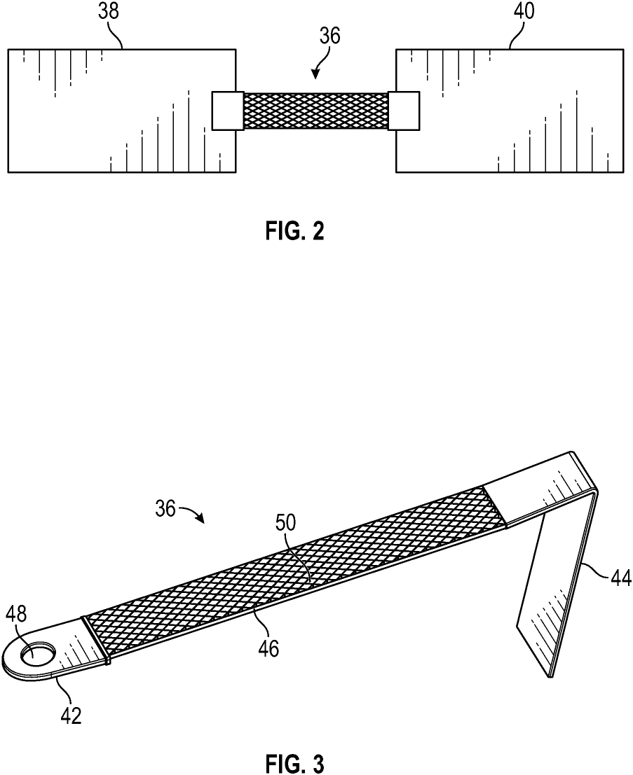

Referring to FIG. 2, with continued reference to FIG. 1, a bus bar assembly 36 may be utilized to electrically couple a first electrical component 38 and a second electrical component 40 of the traction battery pack 24. The bus bar assembly 36 may be configured to carry electrical current between the first and second electrical components 38, 40.

In an embodiment, the bus bar assembly 36 is a component of an electrical distribution system (EDS) of the traction battery pack 24 that is designed for electrically distributing power within and to/from the traction battery pack 24. Although only a single bus bar assembly 36 is shown, the EDS of the traction battery pack 24 could include a plurality of bus bar assemblies.

In an embodiment, the first and second electrical components 38, 40 are two adjacent battery arrays 25 of the traction battery pack 24. In another embodiment, the first electrical component 38 is one of the battery arrays 25 of the traction battery pack 24 and the second electrical component 40 is a bussed electrical center (BEC) of the traction battery pack 24. However, the bus bar assembly 36 could be utilized to electrically couple any two components of the traction battery pack 24.

The bus bar assembly 36 is shown schematically in FIG. 2 but is illustrated in greater detail in FIG. 3. The bus bar assembly 36 may include a terminal section 42, an internal bus bar section 44, and a flexible braided mesh section 46 extending between and connecting the terminal section 42 and the internal bus bar section 44.

The terminal section 42 may be configured in the form of an eyelet that includes an opening 48, such as a hole configured to receive a fastener, for example. The size and shape of the terminal section 42 are not intended to limit this disclosure.

The internal bus bar section 44 may be shaped differently from the terminal section 42. In an embodiment, the internal bus bar section 44 is L-shaped. However, other shapes are also contemplated within the scope of this disclosure.

The terminal section 42 and the internal bus bar section 44 may both be made of a metallic material, such as copper, for example. However, other conductive materials may also be utilized within the scope of this disclosure.

The flexible braided mesh section 46 may also be made of a metallic material, such as copper, for example. However, other conductive materials could also be utilized within the scope of this disclosure.

The flexible braided mesh section 46 may include a plurality of braided strands 50. Together, the braided strands 50 provide a path for current to flow through the bus bar assembly 36.

The flexible braided mesh section 46 may be flexible (e.g., non-rigid) in order to allow alter a positioning of the terminal section 42 relative to the internal bus bar section 44. The bus bar assembly 36 may be oriented in various positions and shapes by manipulating the flexible braided mesh section 46. The ability to orient the bus bar assembly 36 as desired may simplify assembly of traction battery pack components, accommodate potential height differences between the traction battery pack components being electrically coupled, reduce the amount of packaging space required to house the traction battery pack components, etc.

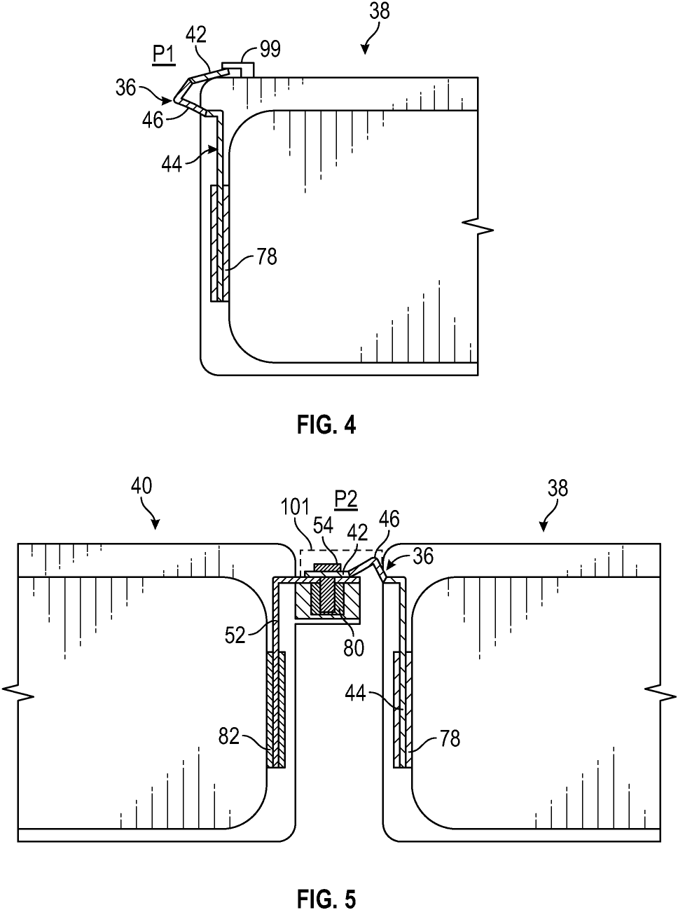

FIG. 4 illustrates a first position P1 of the bus bar assembly 36. The first position P1 may be referred to a folded or stowed position. In this position, the terminal section 42 may be folded to a position that at least partially overlaps the internal bus bar section 44 (which itself may be welded or soldered to a battery cell terminal tab 78 of the first electrical component 38) by manipulating the flexible braided mesh section 46. The first position P1 may be particularly advantageous during shipping and can help protect against short circuit conditions when handling the first electrical component 38.

A retention clip 99 may be used to engage the terminal section 42 in order to hold the flexible braided mesh section 46 in the folded position. The retention clip 99 may be secured to a portion of the first electrical component 38 and may flex in order to move in and out of engagement with the terminal section 42.

FIG. 5 illustrates a second position P2 of the bus bar assembly 36. The second position P2 may be referred to an unfolded or installation position. In this position, the terminal section 42 may be unfolded to a position that is displaced from the internal bus bar section 44 by manipulating the flexible braided mesh section 46. The second position P2 may be particularly advantageous during assembly of the traction battery pack 24. For example, the terminal section 42 may be unfolded to a position over top of a high voltage terminal 52 of the second electrical component 40 when moved to the second position P2. The high voltage terminal 52 may connect to a battery cell terminal tab 82 of the second electrical component 40.

The terminal section 42 of the bus bar assembly 36 may be secured to the high voltage terminal 52, such as by a fastener 54 and a fastener receiver 80 of the second electrical component 40, for example. The bus bar assembly 36 may therefore allow for installing and removing the traction battery pack components in any order, thereby simplifying assembly and servicing tasks.

A cover 101 (shown schematically) may be positioned over the bus bar assembly 36 after securing the terminal section 42 to the high voltage terminal 52. The cover 101 may help prevent access/exposure to high voltage connections of the traction battery pack 24.

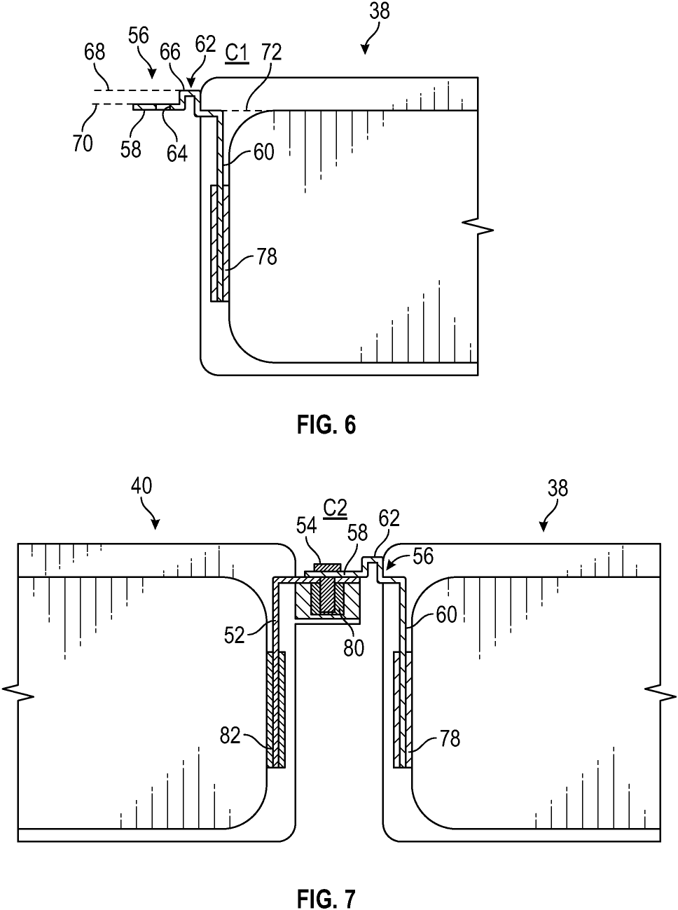

FIGS. 6 and 7 illustrate another exemplary bus bar assembly 56 that can be used to connect first and second electrical components 38, 40 of the traction battery pack 24. In this embodiment, the bus bar assembly 56 is configured as a semi-rigid structure and therefore lacks the inherent flexibility offered by the flexible braided mesh section 46 of the bus bar assembly 36 discussed above.

The bus bar assembly 56 may include a terminal section 58, an internal bus bar section 60, and a top hat section 62 extending between and connecting the terminal section 58 and the internal bus bar section 60.

The terminal section 58 may be configured in the form of an eyelet that includes an opening 64, such as a hole configured to receive a fastener, for example. The internal bus bar section 60 may be shaped differently from the terminal section 58. In an embodiment, the internal bus bar section 60 is L-shaped.

The terminal section 58, the internal bus bar section 60, and the top hat section 62 may each be made of a metallic material, such as copper, for example. However, other conductive materials may also be utilized within the scope of this disclosure.

An upper surface 66 of the top hat section 62 may extend within a first horizontal plane 68 that is vertically offset from a second horizontal plane 70 of the terminal section 58 and a third horizontal plane 72 of the internal bus bar section 60. In an embodiment, the second horizontal plane 70 and the third horizontal plane 72 are also vertically offset from one another.

By virtue of its shape and positioning, the top hat section 62 may lend some conformity to the bus bar assembly 56. The top hat section 62 may further protect high voltage connections during assembly of the traction battery pack components.

FIG. 6 illustrates a first configuration C1 of the bus bar assembly 56. In the first configuration C1, the bus bar assembly 56 is already joined to the first electrical component 38. For example, the internal bus bar section 60 may be welded or soldered to a battery cell terminal tab 78 of the first electrical component 38. The first configuration C1 may be particularly advantageous during shipping (e.g., prior to connection of the first electrical component 38 to another electrical component).

FIG. 7 illustrates a second configuration C2 of the bus bar assembly 56. The second configuration C2 may be an assembly configuration for electrically coupling the first and second electrical components 38, 40. For example, the terminal section 58 of the bus bar assembly 56 may be positioned over top of a high voltage terminal 52 of an already installed second electrical component 40 such that the terminal section 58 overlaps the high voltage terminal 52 (e.g., like a shingle) in the second configuration C2. The high voltage terminal 52 may connect to a battery cell terminal tab 82 of the second electrical component 40. The terminal section 58 may then be secured to the high voltage terminal 52, such as by a fastener 54 and a fastener receiver 80 of the second electrical component 40, for example, for electrically coupling the first and second electrical components 38, 40.

The exemplary bus bar assemblies of this disclosure are designed to provide flexibility when electrically coupling traction battery pack components. The proposed designs reduce the amount of components required to achieve electrical connections, decrease the resistance of high voltage paths, and increase the amount of available packaging space inside the traction battery pack enclosure.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery pack, comprising:
a first electrical component;
a second electrical component; and
a bus bar assembly configured to electrically couple the first and second electrical components, wherein the bus bar assembly includes:
a terminal section;
an internal bus bar section; and
a flexible braided mesh section extending between the terminal section and the internal bus bar section,
wherein the flexible braided mesh section is movable between a folded position and an unfolded position to alter a positioning of the terminal section relative to the internal bus bar section.

2. The battery pack as recited in claim 1, wherein the first electrical component is a first battery array and the second electrical component is a second battery array.

3. The battery pack as recited in claim 1, wherein the first electrical component is a battery array and the second electrical component is a bussed electrical center (BEC).

4. The battery pack as recited in claim 1, wherein the terminal section is fastened to a high voltage terminal of the second electrical component when the flexible braided mesh section is positioned in the unfolded position.

5. The battery pack as recited in claim 4, wherein the high voltage terminal is connected to a battery cell terminal tab.

6. The battery pack as recited in claim 4, wherein the terminal section is fastened to the high voltage terminal with a fastener and a fastener receiver of the second electrical component.

7. The battery pack as recited in claim 1, wherein the internal bus bar section is L-shaped and the terminal section is configured in the form of an eyelet.

8. The battery pack as recited in claim 1, wherein the internal bus bar section is connected to a battery cell terminal tab of the first electrical component.

9. The battery pack as recited in claim 1, wherein the terminal section at least partially overlaps the internal bus bar section in the folded position and is displaced from the internal bus bar section in the unfolded position.

10. The battery pack as recited in claim 1, comprising a flexible clip adapted to engage the terminal section to hold the flexible braided mesh section in the folded position.

11. A battery pack, comprising:
a first electrical component;
a second electrical component; and
a bus bar assembly configured to electrically couple the first and second electrical components, wherein the bus bar assembly includes:
a terminal section;
an internal bus bar section; and
a top hat section connecting between the terminal section and the internal bus bar section.

12. The battery pack as recited in claim 11, wherein the bus bar assembly includes a semi-rigid structure.

13. The battery pack as recited in claim 11, wherein the first electrical component is a first battery array and the second electrical component is a second battery array.

14. The battery pack as recited in claim 11, wherein the first electrical component is a battery array and the second electrical component is a bussed electrical center (BEC).

15. The battery pack as recited in claim 11, wherein the internal bus bar section is L-shaped and the terminal section is configured in the form of an eyelet.

16. The battery pack as recited in claim 11, wherein the internal bus bar section is connected to a battery cell terminal tab of the first electrical component.

17. The battery pack as recited in claim 11, wherein the terminal section is fastened to a high voltage terminal of the second electrical component.

18. The battery pack as recited in claim 17, wherein the terminal section is fastened to the high voltage terminal with a fastener and a fastener receiver of the second electrical component.

19. The battery pack as recited in claim 11, wherein the top hat section extends in a first horizontal plane that is vertically offset from a second horizontal plane established by the terminal section and a third horizontal plane established by the internal bus bar section.

20. The battery pack as recited in claim 19, wherein the second horizontal plane is vertically offset from the third horizontal plane.
